(19) United States
(12) Patent Application Publication
(10) Pub. No.: US 2015/0325118 A1
(43) Pub. Date: Nov. 12, 2015

(54) REMOTE CONTROL ADAPTER AND ADAPTATION METHOD

(71) Applicant: Looq System Inc, Santa Clara, CA (US)

(72) Inventor: Woody Yu, Santa Clara, CA (US)

(73) Assignee: Looq System Inc, Santa Clara, CA (US)

(21) Appl. No.: 14/274,462

(22) Filed: May 9, 2014

(51) Int. Cl. G08C 23/04; H04N 5/44

(52) U.S. Cl. CPC G08C 23/04; H04N 5/4403; H04N 2005/4426; H04N 2005/4425; G08C 2201/93

(57) ABSTRACT

A remote control adapter and an adaptation method include a radio receiving means, an infrared drive means, and an infrared LED, wherein, the radio receiving means establishes with a mobile terminal a radio link for receiving a radio remote control signal from the mobile terminal; the infrared drive means is coupled to the radio receiving means and to the infrared LED for converting the received radio remote control signal into an excitation signal to the infrared LED; the infrared LED emits, based on the excitation signal, an infrared remote control signal to a household electric appliance.

### TECHNICAL FIELD OF THE INVENTION

The present invention relates to the field of radio communication technology, and more particularly to a remote control adapter and an adaptation method.

### DESCRIPTION OF THE RELATED ART

Conventionally, infrared (IR) signals are used in the remote control devices of the traditional household electric appliances. However, with the popularity of various more advanced radio communication means, a lot of new radio interface characteristics such as WiFi, Bluetooth, NFC (Near Field Communication) etc. are added to the new produced smart household electric appliances (such as Smart TV). In this way, the smart household electric appliances are no longer confined to the special remote controllers and are able to receive via various radio interfaces the signals emitted from other smart terminals, realizing the diversification and facilitation of remote control modes, even achieving the richer data interaction. For example, the NFC interface is currently mainly used to perform the pairing of smart TVs with mobile devices (mobile phones, tablet PCs, etc), thus simplifying the application shared data or communication configuration flow. In the course of use of a smart television having the NFC interface, the user may move a mobile phone having the NFC function to make contact with the NFC sensing zone of the smart television, thereby realizing the pairing of the communication module (Bluetooth for example) with that of the smart television. Then, the mobile phone can be used to control the television, achieving the function of a remote controller.

Nevertheless, for the traditional household electric appliances, because they have only IR interface, they can only receive IR remote control signals. The interaction with a smart terminal is possible only when an IR module is integrated in the smart terminal or the related household electric appliance is replaced. As a general rule, intelligent terminals are updated in a faster frequency. IR communication is a relatively outdated mode of communication and has been basically eliminated by the existing intelligent terminals. Accordingly, the incorporation of IR modules only for the purpose of remote control function is clearly unreasonable. In addition, the household electric appliances usually have a longer lifetime. Thus, the complete replacement of a household electric appliance only with the aim of adapting to a new remote control mode is obviously a waste. In this case, it is difficult for the traditional household electric appliances to be compatible with the radio communication mode of intelligent terminals.

### SUMMARY

In view of the aforementioned disadvantages of the prior art, the technical problem to be solved by the present invention is how to make the traditional household electric appliances compatible with the new radio communication modes.

To solve the above problem, the present invention provides a remote control adapter, comprising: a radio receiving means, an infrared drive means, and an infrared LED, wherein,

the radio receiving means establishes with a mobile terminal a radio link for receiving a radio remote control signal from the mobile terminal;

the infrared drive means is coupled to the radio receiving means and to the infrared LED for converting the received radio remote control signal into an excitation signal to the infrared LED;

the infrared LED emits, based on the excitation signal, an infrared remote control signal to a household electric appliance.

Preferably, the radio receiving means is a NFC Reader.

Preferably, the radio receiving means further comprises a Bluetooth module.

Preferably, the remote control adapter further comprises a memory.

Preferably, the remote control adapter is attached to an infrared receiving window of the household electric appliance or is integrated in a hardware of a control device.

Preferably, in the memory is stored the user preset data, based on which an automatic remote control is performed.

In accordance with another aspect of the present invention, there is further proposed a radio-to-infrared remote control adaptation method, comprising the steps of:

S1 detecting continuously whether a mobile terminal enters a radio communication range;

S2 establishing a radio link with a mobile terminal which enters the radio communication range;

S3 receiving a radio remote control signal emitted from the mobile terminal;

S4 converting the received radio remote control signal into an excitation signal to the infrared LED; and

S5 controlling, based on the excitation signal, the emission of an infrared remote control signal from the infrared LED to a household electric appliance.

Preferably, the radio link is a NFC link.

Preferably, the method further comprises, between the step S2 and the step S3, the step of:

S21 achieving by use of the NFC link a Bluetooth pairing with the mobile terminal

Preferably, at the step S3, the radio remote control signal is received and stored in the memory.

According to the technical solution of the present invention, there is proposed a remote control adapter, which can convert a radio remote control signal emitted from a mobile terminal into an infrared remote control signal, thereby realizing the remote control operation of the traditional household electric appliances by the mobile terminal. The present invention is implemented in a simple and easy manner without the need for changing the mobile terminals or the traditional household electric appliances, thereby achieving the compatibility of the traditional electric appliances with a variety of new radio remote control operation modes, prolonging in an effective way the technical lifetime of the traditional household electric appliances.

### BRIEF DESCRIPTION OF THE DRAWINGS

FIG. 1 is a schematic structural diagram of a remote control adapter in an embodiment of the present invention;

FIG. 2 is a schematic structural diagram of a remote control adapter in an another embodiment of the present invention;

FIG. 3 is a schematic flow diagram of a Bluetooth remote control adaptation method in an embodiment of the present invention.

FIG. 4 is a schematic flow diagram of a NFC remote control adaptation method in an another embodiment of the present invention.

### DETAILED DESCRIPTION OF EMBODIMENTS

Hereinafter, the technical solution in the embodiments of the present invention will be clearly and completely described in connection with the accompanying drawings in the embodiments of the present invention. Obviously, the described embodiments are the preferred embodiments for implementing the present invention, and the description herein is for the purpose of explaining the general principles of the present invention and is not intended to limit the scope of the present invention. Accordingly, the protection scope of the present invention should be as defined in the appended claims. Based on the embodiments of the present invention, all other embodiments obtained by persons of ordinary skill in the art under the premise of not making creative efforts belong to the protection scope of the present invention.

The traditional household electric appliances have no means of communication other than IR. However, the existing mobile terminals have generally eliminated the IR modules. In this case, the traditional household electric appliances can not interact with the existing mobile terminals. In the embodiments of the present invention is proposed a remote control adapter for converting the radio signals from the existing mobile terminals into the IR signals, thereby realizing the operation and control of the traditional household electric appliances by the existing mobile terminals.

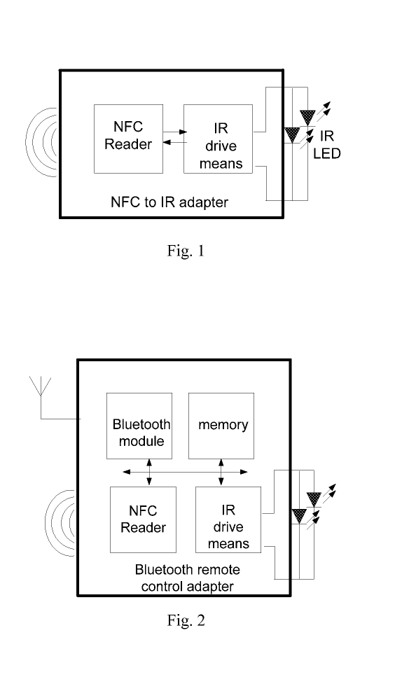

Referring to FIG. 1, in an embodiment of the present invention, a remote control adapter comprises: a radio receiving means, an infrared drive means, and an infrared LED, wherein, the radio receiving means establishes with a mobile terminal a radio link for receiving a radio remote control signal from the mobile terminal, the infrared drive means converts the received radio remote control signal into an excitation signal to the infrared LED, and the infrared LED emits, based on the excitation signal, an infrared remote control signal to a household electric appliance.

In the preferred embodiment of FIG. 1, the radio receiving means is a NFC Reader. Currently, the NFC Readers perform their function basically by using a single chip, and some of them are embedded with a MCU, providing a certain resource for user programming. In the preferred embodiment of the present invention, a NFC-to-IR conversion communication link is established by using such a NFC single chip that: firstly, the mobile terminal such as a mobile phone etc can achieve in an proximity manner the communication with the NFC Reader in the adapter, subsequently the adapter can convert the data from the mobile phone into a infrared signal, then the infrared signal can be further used to control a household electric appliance such as a television etc. In this way a mobile phone—NFC—television control channel can be achieved.

The circuit hardware of the above adapter can be made very small, one square centimeter in size for example, and after being packaged, can be attached in various ways to the infrared receiving window of the television or can be directly incorporated in the hardware of other control devices.

In a more preferred embodiment, a variety of radio communication modes can be realized in the adapter of the present invention. As shown in FIG. 2, the radio receiving means of the remote control adapter further comprises, in addition to a NFC Reader, a Bluetooth module, which enables the mobile terminal to achieve in a NFC manner a Bluetooth pairing with the adapter. Furthermore, the remote control adapter also includes a memory, which can store the data sent from the mobile terminal, making a more complex control mode possible. For example, the user preference channel tables, the timer switch settings, the personalized programs etc can be stored, and then in the course of use, a remote control signal to the television is generated based on the stored content, realizing such functions as the automatic channel selection, the viewing time control, the periodical switching to the fixed programs, etc. Preferably, the mobile terminal can further include a remote control App (application) for offering a more sophisticated user interface in order to achieve the combination and customization of a variety of remote control operations.

Based on the above mentioned remote control adapter, in the embodiment of the present invention is further provided a radio-to-infrared remote control adaptation method, comprising the steps of:

S1 detecting continuously whether a mobile terminal enters a radio communication range;

S2 establishing a radio link with a mobile terminal which enters the radio communication range;

S3 receiving a radio remote control signal emitted from the mobile terminal;

S4 converting the received radio remote control signal into an excitation signal to the infrared LED; and

S5 controlling, based on the excitation signal, the emission of an infrared remote control signal from the infrared LED to a household electric appliance.

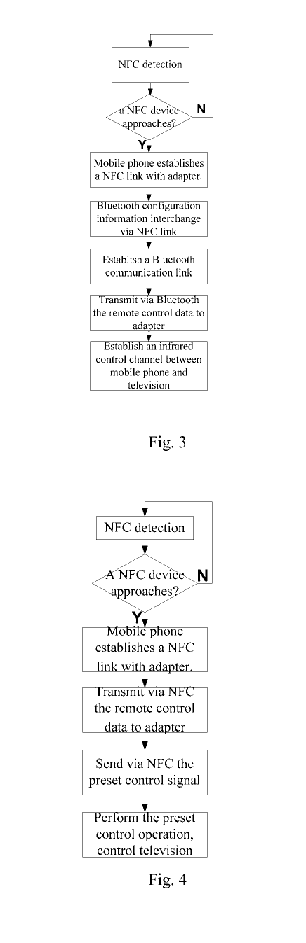

In the flow diagram of FIG. 3 is further illustrated the remote control process via Bluetooth, wherein, the NFC Reader in the adapter detects continuously whether a NFC device enters a communication range; when a mobile terminal having the NFC communication capability (in the present embodiment, a mobile phone for example) enters the communication range, an information interchange between the mobile phone and the adapter is performed to establish a NFC link; then a Bluetooth configuration information interchange between the mobile phone having the Bluetooth module and the adapter is performed via the NFC link; a Bluetooth pairing is achieved, establishing a Bluetooth communication link between the mobile phone and the adapter; the mobile phone transmits via Bluetooth to the adapter the IR data for remote control (to be stored in the memory); a IR control channel between the mobile phone and the television is established (the mobile phone sends a Bluetooth data, the adapter converts the data into an excitation signal to the infrared LED, and then the infrared LED emits an infrared remote control signal to the television), realizing the radio remote control of the television by the mobile phone.

The flow diagram of FIG. 4 illustrates the remote control process only via NFC, wherein, the NFC Reader in the adapter detects continuously whether a NFC device enters a communication range; when a mobile terminal having the NFC communication capability (in the present embodiment, a mobile phone for example) enters the communication range, an information interchange between the mobile phone and the adapter is performed to establish a NFC link; then the mobile phone transmits via the NFC link to the adapter the IR data for remote control (to be stored in the memory); the mobile phone sends via NFC a preset radio remote control signal to the adapter; the adapter converts the signal into an excitation signal to the infrared LED, and then the infrared LED emits an infrared remote control signal to the television, realizing the radio remote control of the television by the mobile phone.

According to the technical solution of the present invention, there is proposed a remote control adapter, which can convert a radio remote control signal emitted from a mobile terminal into an infrared remote control signal, thereby realizing the remote control operation of the traditional household electric appliances by the mobile terminal. The present invention is implemented in a simple and easy manner without the need for changing the mobile terminals or the traditional household electric appliances, thereby achieving the compatibility of the traditional electric appliances with a variety of new radio remote control operation modes, prolonging in an effective way the technical lifetime of the traditional household electric appliances.

The above description illustrates and describes the certain preferred embodiments of the present invention. However, as described hereinabove, it should be understood that, the present invention is not limited to the form disclosed herein, should not be seen as excluding other embodiments, can be used in a variety of other combinations, modifications and environments, and is capable of being changed within the scope of the invention described herein through the above teachings or related areas of technology or knowledge. Any changes and variations made by persons of ordinary skill in the art without departing from the spirit and scope of the present invention should be inside the protection scope defined in the appended claims of the present invention.

1. A remote control adapter, wherein the remote control adapter comprises: a radio receiving means, an infrared drive means, and an infrared LED, wherein,
the radio receiving means establishes with a mobile terminal a radio link for receiving a radio remote control signal from the mobile terminal;
the infrared drive means is coupled to the radio receiving means and to the infrared LED for converting the received radio remote control signal into an excitation signal to the infrared LED; and
the infrared LED emits, based on the excitation signal, an infrared remote control signal to a household electric appliance.

2. The remote control adapter according to claim 1, wherein the radio receiving means is a NFC Reader.

3. The remote control adapter according to claim 2, wherein the radio receiving means further comprises a Bluetooth module.

4. The remote control adapter according to claim 1, wherein the remote control adapter further comprises a memory.

5. The remote control adapter according to claim 1, wherein the remote control adapter is attached to an infrared receiving window of the household electric appliance or is integrated in a hardware of a control device.

6. The remote control adapter according to claim 4, wherein in the memory is stored the user preset data, based on which an automatic remote control is performed.

7. A radio-to-infrared remote control adaptation method, wherein the method comprises the steps of:
S1 detecting continuously whether a mobile terminal enters a radio communication range;
S2 establishing a radio link with a mobile terminal which enters the radio communication range;
S3 receiving a radio remote control signal emitted from the mobile terminal;
S4 converting the received radio remote control signal into an excitation signal to the infrared LED; and
S5 controlling, based on the excitation signal, the emission of an infrared remote control signal from the infrared LED to a household electric appliance.

8. The method according to claim 7, wherein the radio link is a NFC link.

9. The method according to claim 8, wherein the method further comprises, between the step S2 and the step S3, the step of:
S21 achieving by use of the NFC link a Bluetooth pairing with the mobile terminal.

10. The method according to claim 7, wherein at the step S3, the radio remote control signal is received and stored in the memory.

11. The remote control adapter according to claim 2, wherein the remote control adapter further comprises a memory.

12. The remote control adapter according to claim 3, wherein the remote control adapter further comprises a memory.
